(19) United States
(12) Patent Application Publication
(10) Pub. No.: US 2026/0322867 A1
(43) Pub. Date: Oct. 15, 2026

(54) MULTI-STAGE COMUPTING SYSTEMS AND METHODS FOR FILE TRANSFER BETWEEN ON-PREMISE AND CLOUD COMPUTING ENVIRONMENTS

(71) Applicant: The Toronto-Dominion Bank, Toronto (CA)

(72) Inventors: Steven CHIU, Markham (CA); ZeZhong ZHENG, Toronto (CA); Yali XU, Toronto (CA); Upal HOSSAIN, Toronto (CA); Sherman CHUNG, Toronto (CA)

(21) Appl. No.: 19/177,853

(22) Filed: Apr. 14, 2025

(51) Int. Cl. H04L 67/06; H04L 67/1097; H04L 67/568

(52) U.S. Cl. CPC H04L 67/06; H04L 67/1097; H04L 67/568

(57) ABSTRACT

A system and a method are provided for transferring files between a cloud computing environment and an on-premise server, in some cases, for training and developing artificial intelligence (AI) models. The system could be used to transfer files in an adhoc manner in and out of cloud storage, such as when developing a large language model or neural networks. The system coordinates between a ticketing system, an on-premise staging computing system, and an analytic zone in the cloud. The system monitors the review and the transfer of the files, including comparing file data with metadata in a ticket from the ticketing system. The file data is scanned for non-compliant data before the transfer is completed. The scanning occurs when the file is moved through the on-premise staging computing system, which includes a review-folder and an out-folder.

### TECHNICAL FIELD

The disclosed exemplary embodiments relate to a multi-stage computing systems and methods for file transfer between an on-premise computing environment and a cloud computing environment.

### BACKGROUND

Data is often stored in different computing environments for different reasons. In some cases, data is stored on-premise (“on-prem”) for an organization and in some other cases data for the same organization is stored in a cloud computing environment.

In some cases, it is desirable to transfer data between different computing environments, such as the “on-prem” computing environment and the cloud computing environment. In some cases, the data to be transferred includes sensitive data (e.g., private data, confidential data, personally identifiable information, etc.), which can be inadvertently transferred from its current location to a different computing environment (e.g., the on-prem computing environment or the cloud computing environment), thereby exposing the sensitive data. Furthermore, in some cases, data is desired to be transferred on an adhoc basis. For example, users may want to transfer small amounts of data (e.g., one or a few files) at a time.

Manually tracking and transferring these files is inefficient, since the computing systems are often disparate.

In some cases, file transfer occurs during DataOps, which is an integrated computing process for delivering data analytic solutions that uses automation, testing, orchestration, collaborative development, and continuous monitoring to continuously accelerate output for developing software. Inefficiencies in file transfer could delay DataOps computing processes.

### SUMMARY

The following summary is intended to introduce the reader to various aspects of the detailed description, but not to define or delimit any invention.

In at least one broad aspect, a computing system is provided for file transfer. The computing system comprising a ticketing system configured to at least create a ticket associated with a data account to move a file from a first data storage to a second data storage, wherein one of the first data storage and the second data storage is an on-premise data storage and the other one of the first data storage and the second data storage is a cloud computing environment. The computing system further comprising an on-premise staging computing system comprising a review-folder and an out-folder. The on-premise staging computing system is configured to at least: provide a staging database structure comprising a plurality of analytic zone folders; receive the file in a given analytic zone folder from amongst the plurality of analytic zone folders; receive the ticket from the ticketing system and, when a filename of the file corresponds to information in the ticket, transfer the file from the given analytic zone folder to the review folder; responsive to receiving a status update from the ticketing system that the ticket has been approved, transfer the file from the review folder to the out-folder; and transfer the file from the out-folder to a storage folder in the second data storage.

In some cases, the first data storage is the on-premise storage and the second data storage is the cloud computing environment; the file is transferred from the out-folder to the storage folder in an analytic zone in the cloud computing environment; and the analytic zone corresponds to the given analytic zone folder.

In some cases, the information in the ticket comprises: the filename of the file, a zone name of the analytic zone in the cloud computing environment, and a request to transfer data to the analytic zone. In some cases, the information in the ticket also includes a data account name.

In some cases, when the on-premise staging computing system determines that (i) the filename of the file in the given analytic zone folder corresponds to the filename in the ticket and (ii) a folder name of the given analytic zone folder corresponds to the zone name of the analytic zone in the ticket, the on-premise stating computing system moves the file from the given analytic zone folder to the review folder.

In some cases, the on-premise staging computing system is further configured to scan the file in the review folder for non-compliant data and transmit a scan result to the ticketing system; and the ticketing system is further configured to update the ticket with the scan result.

In some cases, the status update from the ticketing system that the ticket has been approved is received when the scan result indicates there is no non-compliant data in the file.

In some cases, the ticket is associated with a data account; a data account folder associated with the data account is provided within the given analytic zone folder; the file is stored in the data account folder; and the data account folder is readable and writeable by the data account.

In some cases, the on-premise staging computing system is further configured to compute a hash of data in the file and transmit the hash to the ticketing system for storage in association with the ticket.

In some cases, the second data storage is the on-premise storage and the first data storage is the cloud computing environment.

In some cases, the file comprises one or more artificial intelligence (AI) models executable in the cloud computing environment; the one or more AI models comprising: a large language model (LLM), a neural network, a conversational AI model, a convolutional neural network (CNN), or a generative adversarial network (GAN), or a combination thereof.

In at least another broad aspect, a method for file transfer is provided. The method comprises: a ticketing system creating a ticket associated with a data account to move a file from a first data storage to a second data storage, wherein one of the first data storage and the second data storage is an on-premise data storage and the other one of the first data storage and the second data storage is a cloud computing environment. The method further comprises: an on-premise staging computing system comprising a review-folder and an out-folder. The on-premise staging computing system at least: provides a staging database structure comprising a plurality of analytic zone folders; receives the file in a given analytic zone folder from amongst the plurality of analytic zone folders; receives the ticket from the ticketing system and, when a filename of the file corresponds to information in the ticket, transfers the file from the given analytic zone folder to the review folder; responsive to receiving a status update from the ticketing system that the ticket has been approved, transfers the file from the review folder to the out-folder; and transfers the file from the out-folder to a storage folder in the second data storage.

In some cases, the first data storage is the on-premise storage and the second data storage is the cloud computing environment; the file is transferred from the out-folder to the storage folder in an analytic zone in the cloud computing environment; and the analytic zone corresponds to the given analytic zone folder.

In some cases, the information in the ticket comprises: the filename of the file, a zone name of the analytic zone in the cloud computing environment, and a request to transfer data to the analytic zone. In some cases, the information in the ticket also includes a data account name.

In some cases, when the on-premise staging computing system determines that (i) the filename of the file in the given analytic zone folder corresponds to the filename in the ticket and (ii) a folder name of the given analytic zone folder corresponds to the zone name of the analytic zone in the ticket, the on-premise stating computing system moves the file from the given analytic zone folder to the review folder.

In some cases, the method further comprises the on-premise staging computing system scanning the file in the review folder for non-compliant data and transmitting a scan result to the ticketing system; and the ticketing system updating the ticket with the scan result.

In some cases, the status update from the ticketing system that the ticket has been approved is received when the scan result indicates there is no non-compliant data in the file.

In some cases, the ticket is associated with a data account; a data account folder associated with the data account is provided within the given analytic zone folder; the file is stored in the data account folder; and the data account folder is readable and writeable by the data account.

In some cases, the method further comprises the on-premise staging computing system computing a hash of data in the file and transmitting the hash to the ticketing system for storage in association with the ticket.

In some cases, the file comprises one or more AI models executable in the cloud computing environment; the one or more AI models comprising: a LLM, a neural network, a conversational AI model, a CNN, or a GAN, or a combination thereof.

According to some aspects, the present disclosure provides a non-transitory computer-readable medium storing computer-executable instructions. The computer-executable instructions, when executed, configure a processor to perform any of the methods described herein. For example, a non-transitory computer readable medium is provided storing computer executable instructions which, when executed by at least one computer processor, cause the at least one computer processor to carry out one or more methods for machine learning as described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for processing documents in accordance with at least some embodiments;

FIG. 1B is a schematic block diagram of a cloud computing environment and an on-prem server of FIG. 1A, configured to transfer files therebetween using multiple computing zones in the cloud computing environment and a multi-stage computing system on the on-prem server, in accordance with at least some embodiments;

FIG. 2 is a block diagram of a computer in accordance with at least some embodiments;

FIG. 3 is a schematic block diagram of the on-prem server and the cloud computing environment in FIG. 1B showing an example of the flow of data to transfer a file from the on-prem server to the cloud computing environment, in accordance with at least some embodiments;

FIG. 4 is a schematic block diagram of the on-prem server and the cloud computing environment in FIG. 1B showing an example of the flow of data to transfer a file from the cloud computing environment to the on-prem server, in accordance with at least some embodiments;

FIG. 5 is a schematic block diagram of example data components of a ticket, in accordance with at least some embodiments;

FIG. 6 is a schematic block diagram of an on-prem staging computing system, a data integrator, a centralized data lake storage, and a data integrator self-hosted integration runtime (SHIR), in accordance with at least some embodiments;

FIG. 7 is a flowchart diagram of an example method of transferring a file using an on-prem staging computing system, in accordance with at least some embodiments; and

FIG. 8 is a flowchart diagram of an example method of transferring a file using a cloud computing system, in accordance with at least some embodiments.

### DETAILED DESCRIPTION

Existing computing systems for software development, such as SDLC (software development life cycle), and for DataOps computing processes, have a computing architecture that includes a combination of one or more on-premise (also called “on-prem”) servers and one or more cloud computing systems in a cloud computing environment. In some cases, when developing artificial intelligence (AI) models and machine learning (ML) models, data files are used for training, testing, and fine-tuning models. In some cases, data files include artifacts that are used for developing or revising AI models and ML models. In some cases, the files to be transferred include sensitive data (e.g., private data, confidential data, personally identifiable information, etc.), and transferring the files exposes the sensitive data. In some cases, existing computing systems do not have mechanisms to adapt to adhoc file transfers, which may occur more often in a software development life cycle on in a DataOps process, or both. In some cases, existing computing systems lack integration and do not provide a repeatable process for ingesting and scanning files for sensitive data (e.g., private data, confidential data, personally identifiable information, etc.) prior to transferring the data between an on-prem server and a cloud computing environment.

In some cases, a back-end computing system is provided to transfer files between the one or more on-prem servers and the cloud computing environment, and scanning the files for sensitive data when analyzing requests to transfer files. In some cases, the back-end computing system is provided to facilitate side loading data into an analytics zone in the cloud computing environment on adhoc basis. Furthermore, in some cases, data is desired to be transferred on an adhoc basis. For example, users may want to transfer small amounts of data (e.g., one or a few files) at a time.

In some cases, a computing system is provided for transferring data between different computing environments. One of the computing environments is a cloud computing environment and the other computing environment is an on-premise (also called “on-prem”) computing environment. In some cases, the computing system transfers files safely (e.g., free of sensitive data) and quickly, while tracking data accounts that have initiated the data transfer.

In some cases, the cloud computing environment includes multiple analytics zones that are each used for building, development, and systems integration testing of a software. In some cases, the computing system is configured to transfer data between an analytic zone, which is in the cloud computing environment (like Azure cloud) and an on-prem data source in an ad-hoc manner. In some cases, users may wish to “side load” a file from an on-prem data source to an analytic zone, or vice versa. For example, a file may be on a user’s laptop or on some other on-prem computing device, which is not within an analytics zone. The user desires to transfer the file into the analytics zone so they can prepare data, conduct experiments and/or test data models.

In some cases, the computing system is configured to facilitate the transfer of the file in an ad hoc manner, and provide different stages for review and monitoring of the file. In particular, the computing system is configured to scan the file for sensitive data (such as Personal Identifiable Information (PII) or Payment Card Industry (PCI) non-compliant data).

In some cases, a computing system is provided for file transfer that includes an on-premise computing environment. The on-premise computing environment includes an on-premise ticketing software system; in some cases, Jira a trade name of the on-premise ticketing software. The on-premise computing environment also includes an on-premise staging computing system. In some cases, the on-premise staging computing system is a virtual machine container (VMC) server.

The on-premise staging computing system and the cloud computing environment exchange data with each other. In some cases, in addition to the multiple analytic zones, the cloud computing environment further includes a data factory to move files between itself and the on-premise staging computing system.

Regarding the on-premise computing environment, the on-premise ticketing software system is configured to at least: create a ticket associated with a user to move a file from a first data storage to a second data storage, wherein one of the first data storage and the second data storage is an on-premise data storage and the other one of the first data storage and the second data storage is a cloud computing environment.

In some cases, the on-premise staging computing system includes an in-folder, a review-folder, and an out-folder. When moving a file from the first data storage to the second data storage, the file moves through a sequence of the in-folder, the review folder and the out-folder.

The term “folder” more generally herein refers to a storage space or a container in a computing system for storing and organizing data.

In some cases, the on-premise staging computing system is configured to: provide a staging database structure comprising a plurality of analytic zone folders within the in-folder; receive the file, transferrable from the first storage, in a given analytic zone folder from amongst the plurality of analytic zone folders; receive the ticket from the on-premise ticketing software system and, when a filename of the file corresponds to information in the ticket, transfer the file from the given analytic zone folder to the review folder; responsive to receiving a status update from the on-premise ticketing software system that the ticket has been approved, transfer the file from the review folder to the out-folder; and, when a certain condition is satisfied, transfer the file from the out-folder to a storage folder in the second data storage.

In some cases, the certain condition includes a predetermined time. For example, at a predetermined time, the file is transferred from the out-folder to the storage folder. In some other cases, the certain condition includes an action associated with a data account, and when the action is detected, the file is transferred from the out-folder to the storage folder.

In some cases, the first data storage is the on-premise storage and the second data storage is the cloud computing environment. The file is transferred from the out-folder to the storage folder in an analytic zone in the cloud computing environment, and the analytic zone corresponds to the given analytic zone folder.

The on-premise staging computing system scans the file in the review folder for non-compliant data and transmits a scan result to the on-premise ticketing software system. Non-compliant data, for example, includes personal identifiable information (PII) or Payment Card Industry (PCI) sensitive data, or both. The on-premise ticketing software system updates the ticket with the scan result. In some cases, the status update from the on-premise ticketing software system that the ticket has been approved is received when the scan result indicates there is no non-compliant data in the file.

In some cases, the ticket is created by a data account when the data account initiates a request to transfer a file to or from a given analytic zone. In some cases, the ticket includes the user name, the filename of the file, a zone name of the analytic zone in the cloud computing environment, and a request to transfer data to the analytic zone. In some cases, the user name is also called a data account name.

In the in-folder, the given analytic zone folder further includes a data account folder associated with the data account. The file to be transferred is stored in the data account folder, and the data account folder is readable and writeable by the user. In some cases, the data account initiates transferring the file to the data account folder (within the given analytic zone folder), to undergo the transfer process to the second data storage.

When the on-premise staging computing system determines that (i) the filename of the file in the given analytic zone folder corresponds to the filename in the ticket and (ii) a folder name of the given analytic zone folder corresponds to the zone name of the analytic zone in the ticket, the on-premise stating computing system moves the file from the given analytic zone folder to the review folder.

In some cases, the on-premise staging computing system is further configured to compute a hash of data in the file and transmit the hash to the on-premise ticketing software system for storage in association with the ticket. In other words, the hash becomes part of the ticket.

In some cases, the on-premise staging computing system is configured to batch retrieve a plurality of tickets from the on-premise ticketing software system every n number of minutes. For example, every 30 minutes, the on-premise staging computing system batch retrieves the tickets from Jira.

In some cases, the on-premise staging computing system is configured to batch transfer a plurality of files in the out-folder to a plurality of analytic zones in the cloud computing environment every n number of minutes. For example, every 30 minutes, the on-premise staging computing system batch transfers the files, which have been reviewed and approved, in the out-folder to their respectively designated analytic zones.

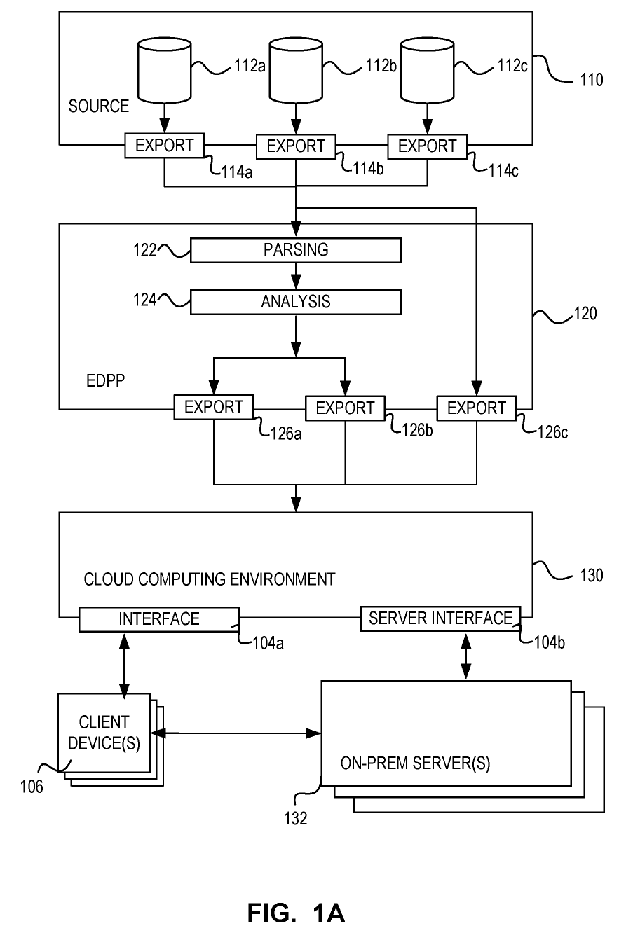

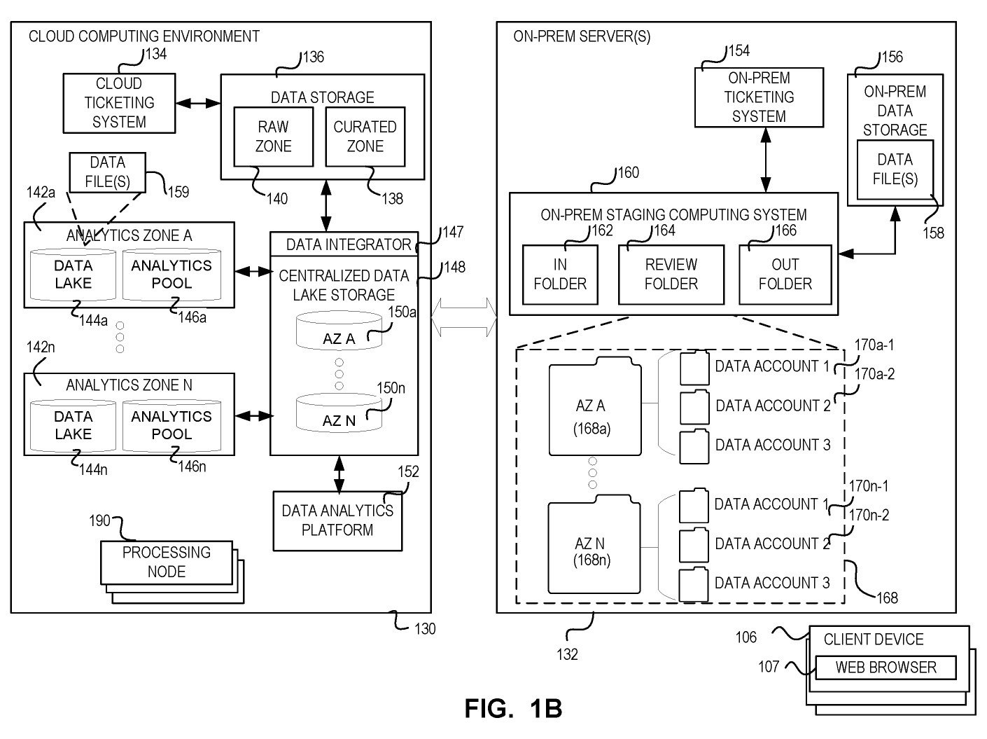

Referring now to FIG. 1A, there is illustrated a block diagram of an example computing system, in accordance with at least some embodiments. Computing system 100 has a source database system 110, an enterprise data provisioning platform (EDPP) 120 operatively coupled to the source database system 110, and a cloud computing environment 130, which in some cases is a cloud-based computing cluster, that is operatively coupled to the EDPP 120. In some cases, this computing system 100 is provided for automated data processing of large data sets, including identify relevant documents to automatically generate responses in relation to a given query. In some cases, the documents are files that include text. In some cases, different data formats of documents or files (or both), and which include text, can be used in the computing system described herein.

Source database system 110 has one or more databases, of which three are shown for illustrative purposes: database 112a, database 112b and database 112c. One or more the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis.

EDPP 120 receives source data exported by the export modules 114 of source database system 110, processes it and exports the processed data to an application database within the cloud computing environment 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to a document or group of documents (e.g., a client document) may be exported via reporting and analysis module 124 or an export module 126. In particular, parsed data can then be processed and transmitted to the cloud computing environment 130 by a reporting and analysis module 124. Alternatively, one or more export modules 126a, 126b, 126c can export the parsed data to the cloud computing environment 130.

In some cases, the cloud computing environment 130 includes an interface 104a, which facilitates communicating with one or more client devices 106. In some cases, the cloud computing environment 130 includes a server interface 104b that facilitates communicating with one or more on-prem servers 132. In some cases, the interface 104a and the server interface 104b are a single interface adapted to facilitate communication with both the client devices 106 and the on-prem servers 132. In some cases, the client devices 106 communicate with the on-prem server 132.

In some environments, the EDPP may be omitted.

Referring now to FIG. 1B, there is illustrated a block diagram of the cloud computing environment 130, showing greater detail of the elements of the cloud computing environment, which may be implemented by processing nodes 190 of a cloud-based computing cluster that are operatively coupled.

In some cases, the components of the cloud computing environment 130 include a cloud ticketing system 134, a data storage 136, a data integrator 147, a centralized data lake storage 148, one more analytics zones 142a, 142n, and a data analytics platform 152. In some cases, the data storage 136 includes a raw zone 140 and a curated zone 138. In some cases, the analytics zone A 142a includes a data lake 144a and an analytics pool 146a, and the analytics zone N 142n includes a data lake 144n and an analytics pool 146n.

In some cases, each analytics zone in the cloud computing environment refers to a collection of computing infrastructure that includes a virtual computing machine and a cloud data storage. In some cases, the cloud data storage is called a data lake or a data lake zone. In some cases, the cloud data storage also includes an analytics pool. In some cases, the analytics pool is a Select Query Language (SQL) pool that stores data in relational tables with columnar storage. In some cases, the analytics pool facilitates processing analytics at a massive scale. In some cases, each zone has a specific function that includes its own consumption pattern of the data within its local cloud data storage.

In some cases, the data integrator 147 and the centralized data lake storage 148 are an integrated computing platform or an integrated cloud computing system. In some cases, the data integrator 147 coordinates the transfer of files and communicates with the cloud ticketing system 134 or an on-prem ticketing system 154, or both. In some cases, the data integrator 147 stores and executed one or more data-driven workflows, also called data pipelines, to ingest data, or process data, or schedule data flows, or transfer data, or monitor data, or a combination thereof. In some the cases, an example of a data integrator is available under the trade name Azure Data Factory.

In some cases, the centralized data lake storage 148 includes data containers 150a, 150n that are respectively linked to the analytics zone A 142a and the analytics zone N 142n.

In some cases, the one or more analytics zones 142a, 142n and the centralized data lake storage 148 transmit data to each other. In some cases, the data analytics platform 152 and the centralized data lake storage 148 transmit data to each other. In some cases, the data storage 136 and the centralized data lake storage 148 transmit data to each other. In some cases, the cloud ticketing system 134 and the data storage 136 transmit data to each other. In some other cases, there are additional data connections in the cloud computing environment that facilitate data transmission between the components.

In some cases, the components of an on-prem server 132 includes an on-prem ticketing system 154, an on-prem data storage 158, and an on-prem staging computing system 160. In some cases, one or more data files in the on-prem data storage 156 are transferred to a data lake or an analytics pool in one or more analytic zones in the cloud computing environment 130. In some other cases, one or more data files 159 in a given analytics zone (e.g., in a data lake 144a) is transferred to an on-prem data storage 156.

In some cases, the on-prem staging computing system 160 includes an in-folder 162, a review-folder b, and an out-folder 166. In some cases, a subset or all of the folders 162, 164,166 have a staging database structure 168 that includes a plurality of analytic zone folders 168a, 168n. In some cases, an analytic zone folder A 168a includes a first data account folder 170a-1 (also herein called a sub-folder) associated with a first data account (also called Data Account 1) and associated with analytic zone A 142a, and a second data account folder 170a-2 associated with a second data account (also called Data Account 2) and associated with analytic zone A 142a.

In some cases, an analytic zone folder N 168n includes a first data account folder 170n-1 associated with a first data account and associated with analytic zone N 142n, and a second data account folder 170n-2 associated with a second data account and associated with analytic zone N 142n.

In some cases, the on-prem ticketing system 154 and the on-prem staging computing system 160 transmit data to each other. In some cases, the on-prem data storage 156 and the on-prem staging computing system 160 transmit data to each other. In some other cases, there are additional data connections in the on-prem server that facilitate data transmission between the components.

In some cases, the cloud ticketing system 134 and the on-prem ticketing system 154 are disparate systems that do not communicate with each other. In some other cases, the cloud ticketing system 134 and the on-prem ticketing system 154 communicate with each other to coordinate the transfer of files. In some cases, the cloud ticketing system 134 and the on-prem ticketing system 154 are accessible by a client device 106, for example, via a web browser 107 on the client device, to generate a request for transferring one or more files.

In some other cases, a cloud ticketing system 134 is accessible by the on-prem server 132 and the one or more client devices 106. The cloud ticketing system 134 also communicates with the on-prem staging computing system 160 to coordinate the transfer of files.

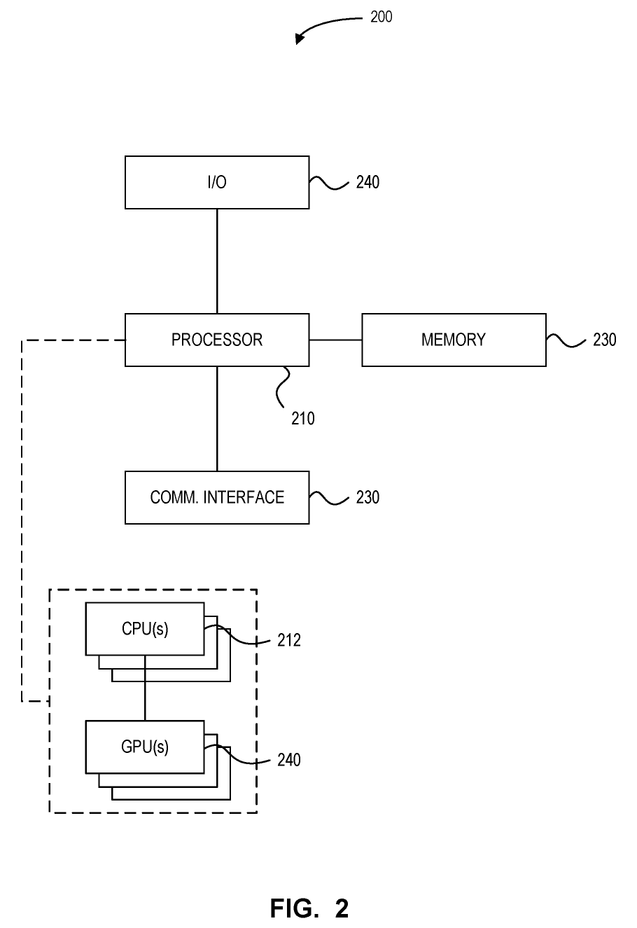

Referring now to FIG. 2, there is illustrated a simplified block diagram of a computer 200 in accordance with at least some embodiments. The computer 200 is also herein interchangeably called a computing system. Computer 200 is an example implementation of a computer such as source database system 110, EDPP 120, processing node 190 of FIGS. 1A and 1B. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data – e.g., within a database – along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. For example, an AI model executes neural network computations on CPU and GPU hardware, such as the system of CPUs 212 and GPUs 214.

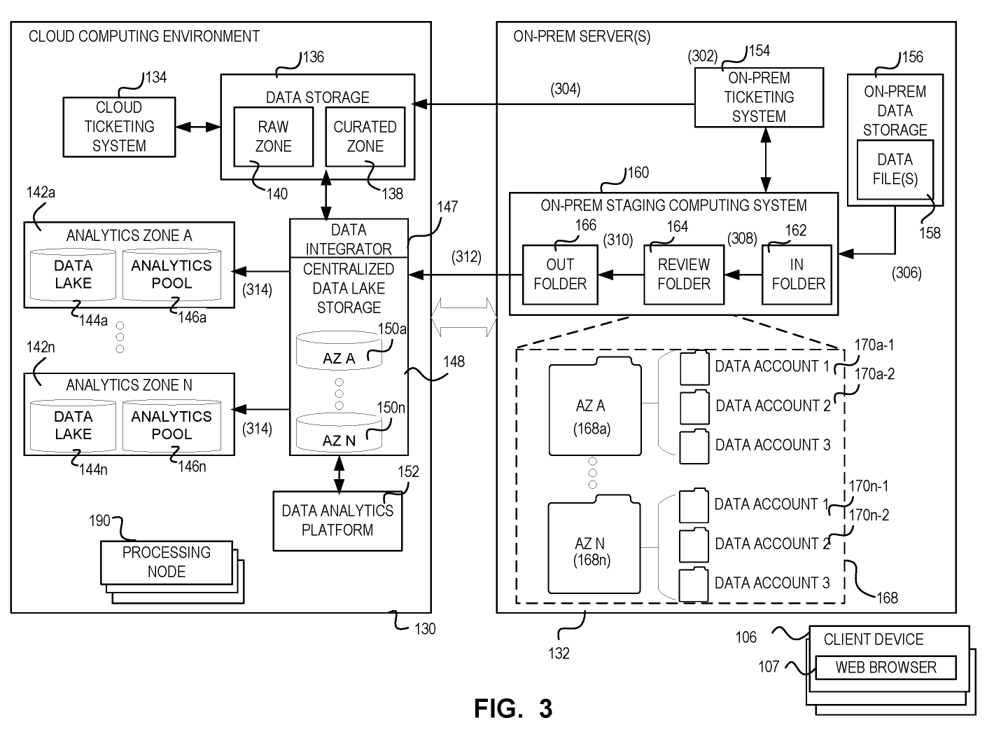

Referring now to FIG. 3, a data flow is shown for transferring a file from an on-prem server 132 to a cloud computing environment 130.

At operation 302, the on-prem ticket system 154 generates a ticket. In some cases, a ticket includes data specifying one or more files to be transferred from the on-prem server 132 to an analytic zone in the cloud computing environment 130. The ticket refers to a data file or a data entry associated with metadata specifying the one or more files to be transferred. In some cases, the metadata includes a name or identity of the one or more files to transferred, the file location on the on-prem server, and a name or identity of the analytic zone. Other data can be included in the metadata.

At operation 304, metadata associated with the ticket is transmitted into the data storage 136, which is within the cloud computing environment 130. In some cases, the ticket, including its metadata, are stored in the raw zone 140. In some cases, a batch of tickets (e.g., a plurality of tickets) from the on-prem ticket system 154 are transferred to the data storage 136 for processing. In some cases, the ticket undergoes a validation process to ensure one or more parameters of the ticket meet one or more predetermined conditions for a file transfer.

At operation 306, one or more data files, which are associated with the ticket, are received and stored in the in-folder 162. In some cases, the transfer of the one or more files to the in-folder uses a file transfer protocol (FTP). In some cases, the transfer of the one or more files to the in-folder uses a secure FTP (SFTP). In some cases, the transfer of the one or more files to the in-folder uses a WinSock FTP, also identified by its tradename WS_FTP. In some cases, the one or more files are stored in a specific in-folder (or a specific sub-folder within the in-folder) that is assigned or linked to a given data account and a given analytics zone and, in some cases, the identities of the given data account and the given analytics zone are specified in the ticket. In some cases, the identities of the given data account and the given analytics zone metadata are metadata of the ticket.

At operation 308, the on-premise staging computing system 160 transfers the one or more files from the in-folder 162 to the review-folder 164. In some cases, the one or more files are stored in a specific review-folder (or a specific sub-folder within the review-folder) that is assigned or linked to the given data account and the given analytics zone.

At operation 310, a review process of the one or more files is executed. In some cases, the one or more files are scanned for sensitive data. When the one or more files are marked to indicate they are approved, the on-premise staging computing system 160 transfers the one or more files from the review-folder 164 to the out-folder 166. In some cases, the one or more files are stored in a specific out-folder (or a specific sub-folder within the out-folder) that is assigned or linked to the given data account and the given analytics zone.

In some cases, the on-premise staging computing system scans the one or more files in the review-folder for non-compliant data (also called sensitive data) and transmits a scan result to the ticketing system. The ticketing system updates the ticket with the scan result. For example, a status update that the ticket has been approved occrus when the scan result indicates the non-compliant data is not detected in the file.

At operation 312, the one or more files are transferred from the out-folder 166 to the centralized data lake storage 148.

At operation 314, the one or more files are moved from the centralized data lake storage 148 to the given analytics zone specified in the ticket.

In some cases, at least one of the analytic zones is an analytics security zone. For example, the analytics zone N 142n is an analytics security zone. In some cases, the analytics security zone includes processes to provide additional scanning of data, or implements data security protocols, or provides user access control for potentially unsafe data, or a combination thereof. In some cases, for any files that were unable to be scanned in the on-premise staging computing system, herein called non-scannable files, these non-scannable files are transferred from the out-folder to a folder in the centralized data lake that is specific to the analytics security zone. The non-scannable files are then moved from the centralized data lake system to the analytics security zone.

In other words, non-scannable files that were designated to go to a designated analytics zone are instead transferred to the analytics security zone to improve data security and safety.

In some cases, the data integrator 147 monitors the stages of the file transfer in the cloud computing environment 130 and automatically moves the one or more files in the cloud computing environment according to the above process. In some cases, data integrator sends and receives data with the on-prem ticketing system or the cloud ticketing system, to coordinate updates regarding the stages of the file transfer.

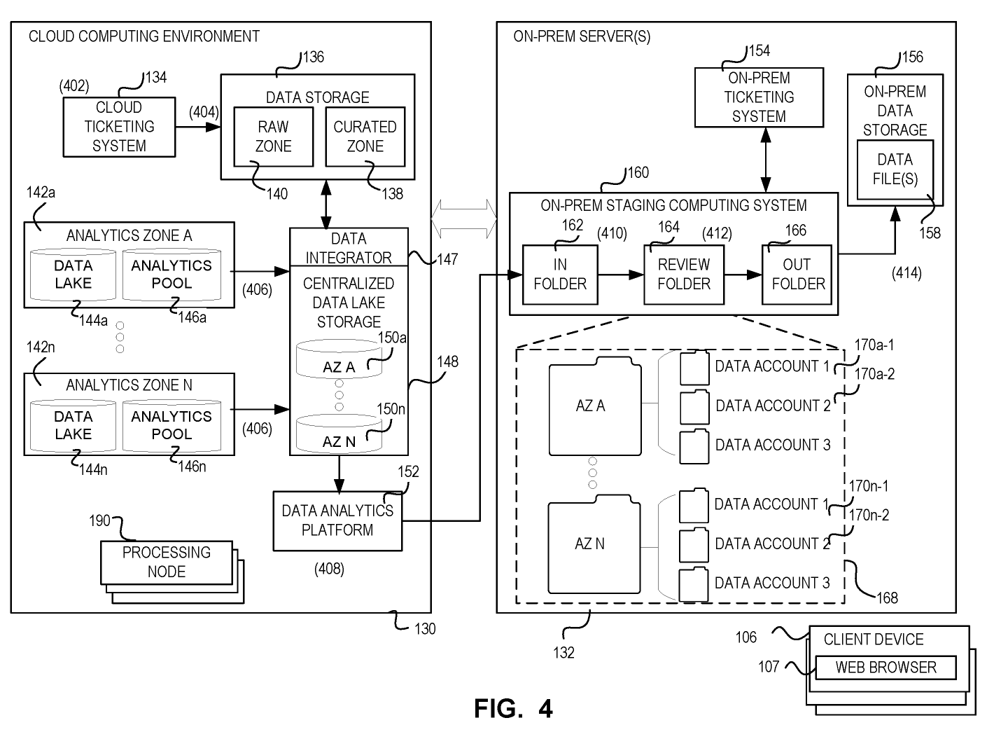

Referring now to FIG. 4, a data flow is shown for transferring one or more files from a cloud computing environment 130 to an on-prem server 132.

At operation 402, a ticket is generated. In some cases, the ticket is generated by a cloud ticketing system 134. In some cases, the ticket includes metadata identifying a data account, a name or identity of the one or more files to be transferred, one or more given analytics zones in the cloud computing environment identifying the location of the one or more files, and a folder identity or name on the on-prem server identifying the location to which the one or more files are to be transferred. Other data can be included in the metadata.

At operation 404, metadata associated with the ticket is transmitted into the data storage 136, which is within the cloud computing environment 130. In some cases, the ticket, including its metadata, are stored in the raw zone 140. In some cases, a batch of tickets (e.g., a plurality of tickets) from the cloud ticketing system 134 are transferred to the data storage 136 for processing. In some cases, the ticket undergoes a validation process to ensure one or more parameters of the ticket meet one or more predetermined conditions for a file transfer.

At operation 406, the one or more files are transferred from the one or more given analytics zones to the centralized data lake storage 148. For example, if a file is in the analytics zone A 142a, then it is transferred and stored in a data container 150a corresponding to the analytics zone A 142a in the centralized data lake storage 148.

At operation 408, the one or more files are transferred from the centralized data lake storage 148 to a corresponding sub-folder in the in-folder 162 on the on-prem server 132. In some cases, the ticket to transfer the one or more files from analytics zone A 142a is associated with Data Account 1; accordingly the one or more files are transferred to a first data account folder 170a-1 in the in-folder 162, which is associated with the analytics zone A 142a and the Data Account 1. This staging database structure 168 occurs in the in-folder 162, the review-folder 164, and the out-folder 166.

In some cases, the analytics platform determines if any of the one or more files are larger than a certain size (also herein called a “large file”), and automatically compresses the large file.

At operation 410, the one or more files are moved from the in-folder to the review-folder.

At operation 412, the one or more files are moved from the review foldr to the out-folder.

At operation 414, the one or more files are moved from the out-folder to the on-prem folder specified in the ticket. In some cases, this transfer is made using a file transfer protocol. In some cases, the protocol is WS-FTP.

In some cases, the data integrator 147 monitors the stages of the file transfer in the cloud computing environment 130 and automatically moves the one or more files in the cloud computing environment according to the above process. In some cases, data integrator sends and receives data with the cloud ticketing system or the on-prem ticketing system, or both, to coordinate updates regarding the stages of the file transfer.

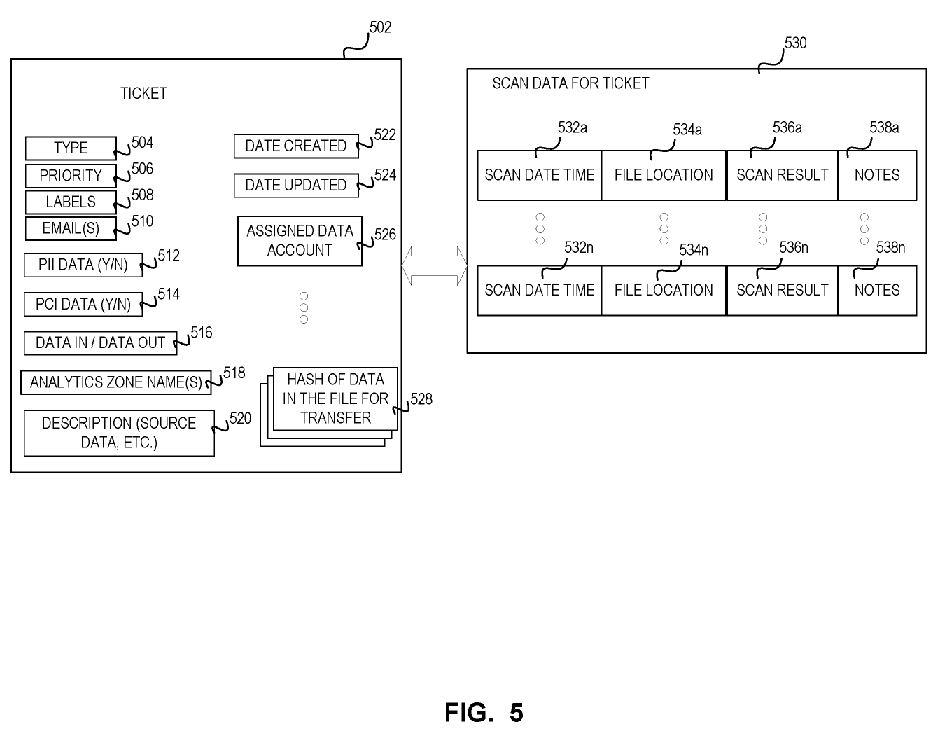

Referring now to FIG. 5, in some cases a ticket 502 is provided that includes different types of metadata. In some cases, the metadata of the ticket includes a type 504 of the ticket. In some cases, the type specifies the ticket is a request to transfer one or more files. In some cases, the metadata includes a priority 506, one or more labels 508, and one or more email addresses 510 associated with the ticket. For example, updates about the file transfer are sent to the one or more email addresses. In some cases, the priority is a value specifying whether the ticket is a high priority, a medium priority or a low priority, or some other value scale. In some cases, the labels can be applied specifying other keywords.

In some cases, the metadata of the ticket includes a PII data tag 512 or a PCI data tag 514, or both. In some cases, the PII data tag 512 specifies whether or not there is PII data in the one or more files, and the PCI data tag 514 specifies whether or not there is PCI data in the one or more files. In some cases the value of these tags is a Boolean value. In some cases, the on-prem staging computing system automatically scans the one or more files for PII data, or PCI data, or other sensitive data, or a combination thereof, and the scan results are used to update the PII data tag 512, or the PCI data tag 514, or a “sensitive data tag”, or a combination thereof.

In some cases, the metadata of the ticket includes a data in/data out tag 516, which specifies if the file transfer is to move data into the cloud computing environment 130 from the on-prem server 132, or to move data out of the cloud computing environment 130 to the on-prem server 132.

In some cases, the metadata of the ticket includes one or more analytic zone names 518 associated with the file transfer. In some cases, the metadata of the ticket includes a description of the file transfer, such as the source data associated with the file, the name of the one or more files to be transferred, the source location, or the source destination, or a combination thereof.

In some cases, the metadata of the ticket includes the date of creation of the ticket 522, the date the ticket was last updated 524, and one or more assigned data accounts 526 associated with the ticket.

In some cases, the metadata of the ticket 502 includes a hash 528 (also called a hash code or a hash value) of the data in the one or more files to be transferred. In some cases, a hashing function is applied to the data of the one or more files to generate the hash. The hash is used by a computing system (including an on-prem computing system a computing system in a cloud computing environment) to verify the contents of the one or more files that have been transferred. In some cases, the hash 528 is computed before the file transfer is executed, also called a pre-transfer-hash. After the transfer, a hashing function is applied to the transferred one or more files to generate a post-transfer-has, and compared with the pre-transfer-hash stored in the ticket to determine if they are the same. When the pre-transfer-hash and the post-transfer-hash are the same, the file transfer is classified as successful. In some cases, when the pre-transfer-hash and the post-transfer-hash are different, the file transfer is considered incomplete or classified as a failure. In some cases, the on-premise staging computing system computes the hash, and transmits the hash to the on-premise ticketing system for storage in association with the ticket. In some other cases, the data integrator 147 hashes the data in the one or more files. For example, the process of hashing is part of a data pipeline executed by the data integrator.

In some cases, when there are multiple files identified in the ticket for file transfer, multiple hashes are computed respectively corresponding to the multiple files.

In some cases, on-prem staging computing system 160 scans the one or more files, and scan data 530 is recorded and stored in association with the ticket 502. In some cases, the scan data 530 is part of the ticket. In some cases, there are multiple entries associated respectively with multiple scans for the one or more files. For example, at a first time, an entry in the scan data includes a scan date time 532a of when a first scan occurred, a file location 534a of a first file (from amongst the one or more file to be transferred), a scan result 536a, and notes 538a associated with the scan. In some cases, the scan is for sensitive data, and the scan result indicates if any sensitive data was detected. For example, if no sensitive data was detected, then the scan result is a pass or a success. In some cases, the notes specify the type of sensitive data uncovered, the number of instances of sensitive data, or other related scan data.

In some cases, a second entry includes a scan date time 532n of when a second scan occurred, a file location 534n of a second file (from amongst the one or more files to be transferred), a scan result 536n, and notes 538n associated with the scan.

In some cases, the data integrator 147 scans for files or tickets (or both) in the data storage 136, or the centralized data lake storage 148 (or both) every x minutes. When a new file is detected, or a new ticket is detected, the data integrator 147 executes the process for transferring a file in the cloud computing environment 130.

In some cases, the on-premise stage computing system 160 scans for files or tickets (or both) in the on-prem ticketing system 154, or in any of the in-folder 162, the review-folder 164, and the out-folder 166, (or any combination thereof both) every y minutes. When a new file is detected, or a new ticket is detected, the on-premise stage computing system 160 executes the process for transferring a file in the on-prem server 132.

In some cases, the information in the ticket includes: a user name, the filename of the file, a zone name of the analytic zone in the cloud computing environment, and a request to transfer data to the analytic zone. In some cases, when the on-premise staging computing system determines that (i) the filename of the file in the given analytic zone folder corresponds to the filename in the ticket and (ii) a folder name of the given analytic zone folder corresponds to the zone name of the analytic zone in the ticket, the on-premise stating computing system moves the file from the given analytic zone folder to the review folder.

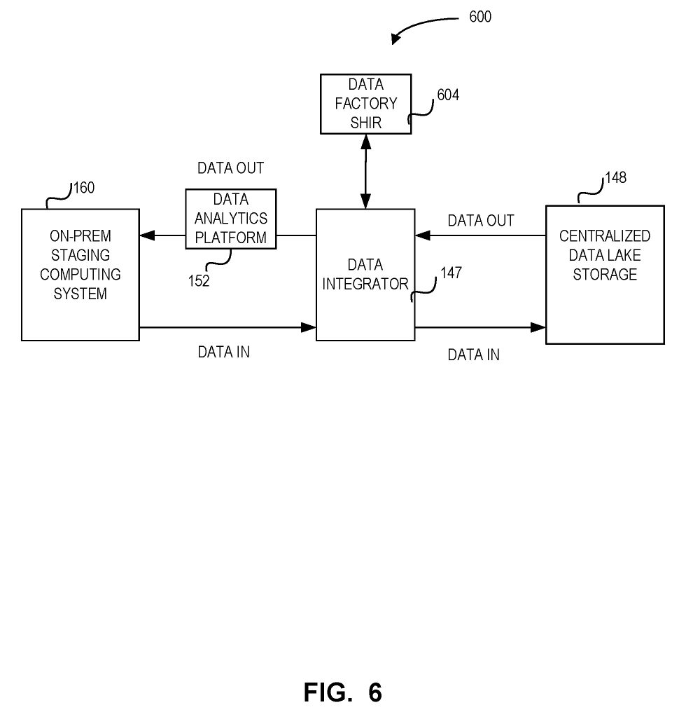

Referring to FIG. 6, an example system architecture 600 is provided that includes the data integrator 147 as an intermediary between the centralized data lake storage 148 and the on-prem staging computing system 160. When moving a file from the on-prem staging computing system to the centralized data lake storage, the file passes through the data integrator. When moving a file from the centralized data lake storage to the on-prem staging computing system, the file passes through the data integrator and the data analytics platform 152.

In some cases, the on-prem staging computing system is SFTP enabled for secure file transfer. In some cases, the on-prem staging computing system is a conduit to the cloud computing environment. In some cases, the on-prem staging computing system includes a mechanism for only approved files to be transferred to the cloud computing environment. In some cases, the on-prem stating computing system is a virtual machine (VM).

In some cases, a data factory with self-hosted integration runtime (SHIR) 604 secures the connectivity between the on-premise staging computing system and the cloud computing environment. In some cases, the data factory with SHIR 604 communicates with the data integrator 147.

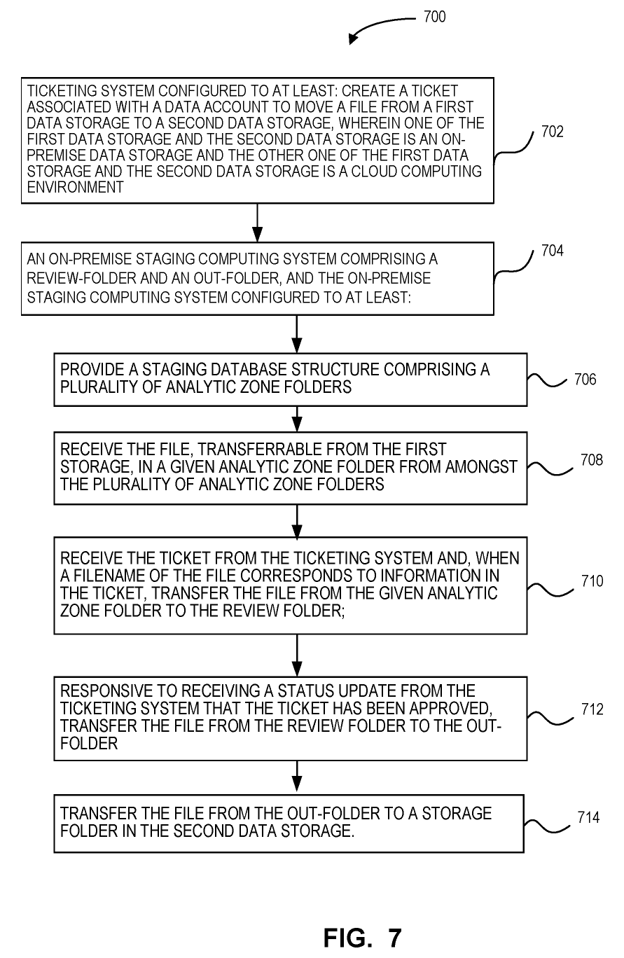

Referring to FIG. 7, a method 700 is provided for transferring a file.

Block 702: A ticketing system is configured to at least: create a ticket associated with a user to move a file from a first data storage to a second data storage, wherein one of the first data storage and the second data storage is an on-premise data storage and the other one of the first data storage and the second data storage is a cloud computing environment.

In some cases, the ticketing system is an on-premise ticketing system. In some case, the ticketing system is a cloud ticketing system. In some cases, the ticketing system is a hybrid ticketing system, including both cloud and on-premise modules.

Block 704: An on-premise staging computing system is provided comprising a review-folder and an out-folder. The on-premise staging computing system configured to at least execute the below operations.

Block 706: Provide a staging database structure comprising a plurality of analytic zone folders.

Block 708: Receive the file, transferrable from the first storage, in a given analytic zone folder from amongst the plurality of analytic zone folders. In some cases, the file is received in the given analytic zone folder, which is within an in-folder in the on-premise staging computing system.

Block b: Receive the ticket from the ticketing system and, when a filename of the file corresponds to information in the ticket, transfer the file from the given analytic zone folder to the review folder.

Block 712: Responsive to receiving a status update from the ticketing system that the ticket has been approved, transfer the file from the review folder to the out-folder.

Block 714: Transfer the file from the out-folder to a storage folder in the second data storage.

In some cases, the first data storage is the on-premise storage and the second data storage is the cloud computing environment. In this case, the file is transferred from the out-folder to the storage folder in an analytic zone in the cloud computing environment; and the analytic zone corresponds to the given analytic zone folder.

In some cases, the second data storage is the on-premise storage and the first data storage is the cloud computing environment.

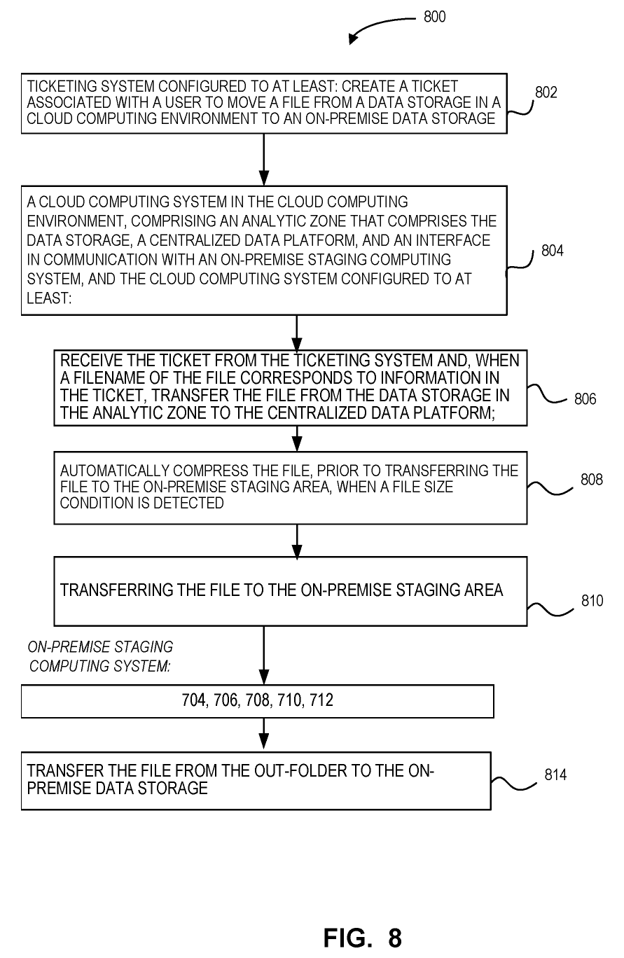

Referring to FIG. 8, a method 800 is provided for transferring a file from a cloud computing environment to an on-prem data storage.

Blocks 802 to 810 are executed by a computing system in a cloud computing environment.

Block 802: Use a ticketing system to at least: create a ticket associated with a data account to move a file from a data storage in a cloud computing environment to an on-prem data storage.

Block 804: A cloud computing system is provided in the cloud computing environment. The cloud computing system includes an analytic zone that comprises the data storage, a centralized data platform, and an interface in communication with an on-prem staging computing system. The cloud computing system configured to at least execute the operations in blocks 806 to 810.

Block 806: The cloud computing system receives the ticket from the ticketing system and, when a filename of the file corresponds to information in the ticket, transfers the file from the data storage in the analytic zone to the centralized data platform.

Block 808: The cloud computing system automatically compresses the file, prior to transferring the file to the on-premise staging area, when a file size condition is detected.

Block 810: The cloud computing system transfers the file to the on-premise staging area.

The following blocks are executed by the on-prem staging computing system.

Blocks 704, 706, 708, 710 and 712 are executed.

Block 814: The on-prem staging computing system transfers the file from the out-folder to the on-prem data storage.

In some cases, the one or more files being transferred includes one or more artificial intelligence (AI) models executable in the cloud computing environment. For example, the one or more AI models include: a large language model, a neural network, a conversational AI model, a convolutional neural network (CNN), or a generative adversarial network (GAN), or a combination thereof. In some cases, the one or more files include data or artifacts for training or fine tuning an AI model.

In some cases, the one or more files being transferred includes: a JavaScript Object Notation (JSON) file, a data log, a Portable Document Format (PDF) file, a Hypertext Markup Language (HTML) file, a text file, a spreadsheet, an Extensible Markup Language (XML) file, or an image file, or a combination thereof.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as "substantially", "about", and "approximately" as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term "about" which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A computing system for file transfer, comprising:
a ticketing system configured to at least: create a ticket to move a file from a first data storage to a second data storage, wherein one of the first data storage and the second data storage is an on-premise data storage and the other is in a cloud computing environment; and
an on-premise staging computing system comprising a review-folder and an out-folder, the on-premise staging computing system configured to at least:
provide a plurality of analytic zone folders;
receive the file in a given analytic zone folder from amongst the plurality of analytic zone folders;
receive the ticket from the ticketing system and, when a filename of the file corresponds to information in the ticket, transfer the file from the given analytic zone folder to the review-folder;
responsive to receiving a status update from the ticketing system that the ticket has been approved, transfer the file from the review-folder to the out-folder; and
transfer the file from the out-folder to a storage folder in the second data storage.

2. The computing system of claim 1, wherein the first data storage is the on-premise storage and the second data storage is the cloud computing environment; the file is transferred from the out-folder to the storage folder in an analytic zone in the cloud computing environment; and the analytic zone corresponds to the given analytic zone folder.

3. The computing system of claim 1, wherein the information in the ticket comprises: the filename of the file, a zone name of the analytic zone in the cloud computing environment, and a request to transfer data to the analytic zone.

4. The computing system of claim 3, wherein, when the on-premise staging computing system determines that (i) the filename of the file in the given analytic zone folder corresponds to the filename in the ticket and (ii) a folder name of the given analytic zone folder corresponds to the zone name of the analytic zone in the ticket, the on-premise staging computing system moves the file from the given analytic zone folder to the review-folder.

5. The computing system of claim 1, wherein the on-premise staging computing system is further configured to scan the file in the review-folder for non-compliant data and transmit a scan result to the ticketing system; and the ticketing system is further configured to update the ticket with the scan result.

6. The computing system of claim 5, wherein the status update from the ticketing system that the ticket has been approved is received when the scan result indicates the non-compliant data is not detected in the file.

7. The computing system of claim 1, wherein the ticket is associated with a data account; a data account folder associated with the data account is provided within the given analytic zone folder; the file is stored in the data account folder; and the data account folder is readable and writeable by the data account.

8. The computing system of claim 1, wherein the on-premise staging computing system is further configured to compute a hash of data in the file and transmit the hash to the ticketing system for storage in association with the ticket.

9. The computing system of claim 1, wherein the second data storage is the on-premise storage and the first data storage is the cloud computing environment.

10. The computing system of claim 1, wherein the file comprises one or more artificial intelligence (AI) models executable in the cloud computing environment; the one or more AI models comprising: a large language model (LLM), a neural network, a conversational AI model, a convolutional neural network (CNN), or a generative adversarial network (GAN), or a combination thereof.

11. A method for file transfer, the method comprising:
a ticketing system creating a ticket associated with a data account to move a file from a first data storage to a second data storage, wherein one of the first data storage and the second data storage is an on-premise data storage and the other one of the first data storage and the second data storage is a cloud computing environment; and
an on-premise staging computing system comprising a review-folder and an out-folder, and the on-premise staging computing system at least:
providing a staging database structure comprising a plurality of analytic zone folders;
receiving the file in a given analytic zone folder from amongst the plurality of analytic zone folders;
receiving the ticket from the ticketing system and, when a filename of the file corresponds to information in the ticket, transfer the file from the given analytic zone folder to the review-folder;
responsive to receiving a status update from the ticketing system that the ticket has been approved, transferring the file from the review-folder to the out-folder; and
transferring the file from the out-folder to a storage folder in the second data storage.

12. The method of claim 11, wherein the first data storage is the on-premise storage and the second data storage is the cloud computing environment; the file is transferred from the out-folder to the storage folder in an analytic zone in the cloud computing environment; and the analytic zone corresponds to the given analytic zone folder.

13. The method of claim 12, wherein the information in the ticket comprises: the filename of the file, a zone name of the analytic zone in the cloud computing environment, and a request to transfer data to the analytic zone.

14. The method of claim 13, wherein, when the on-premise staging computing system determines that (i) the filename of the file in the given analytic zone folder corresponds to the filename in the ticket and (ii) a folder name of the given analytic zone folder corresponds to the zone name of the analytic zone in the ticket, the on-premise staging computing system moves the file from the given analytic zone folder to the review-folder.

15. The method of claim 11, further comprising the on-premise staging computing system scanning the file in the review-folder for non-compliant data and transmitting a scan result to the ticketing system; and the ticketing system updating the ticket with the scan result.

16. The method of claim 15, wherein the status update from the ticketing system that the ticket has been approved is received when the scan result indicates the non-compliant data is not detected in the file.

17. The method of claim 11, wherein the ticket is associated with a data account; a data account folder associated with the data account is provided within the given analytic zone folder; the file is stored in the data account folder; and the data account folder is readable and writeable by the data account.

18. The method of claim 11, further comprising the on-premise staging computing system computing a hash of data in the file and transmitting the hash to the ticketing system for storage in association with the ticket.

19. The method of claim 11, wherein the file comprises one or more artificial intelligence (AI) models executable in the cloud computing environment; the one or more AI models comprising: a large language model (LLM), a neural network, a conversational AI model, a convolutional neural network (CNN), or a generative adversarial network (GAN), or a combination thereof.

20. A non-transitory computer readable medium storing computer executable instructions which, when executed by at least one computer processor, cause the at least one computer processor to carry out a method for transferring a file, the method comprising:
a ticketing system creating a ticket associated with a data account to move the file from a first data storage to a second data storage, wherein one of the first data storage and the second data storage is an on-premise data storage and the other one of the first data storage and the second data storage is a cloud computing environment; and
an on-premise staging computing system comprising an in-folder, a review-folder, and an out-folder, and the on-premise staging computing system at least:
providing a staging database structure comprising a plurality of analytic zone folders;
receiving the file in a given analytic zone folder from amongst the plurality of analytic zone folders;
receiving the ticket from the ticketing system and, when a filename of the file corresponds to information in the ticket, transfer the file from the given analytic zone folder to the review-folder;
responsive to receiving a status update from the ticketing system that the ticket has been approved, transferring the file from the review-folder to the out-folder; and
transferring the file from the out-folder to a storage folder in the second data storage.
